(19) United States
(12) Patent Application Publication
(10) Pub. No.: US 2005/0033567 A1
(43) Pub. Date: Feb. 10, 2005

(54) Alignment system and aligning method for multilingual documents

(76) Inventor: Tatsuya Sukehiro, Osaka (JP)

Correspondence Address: RABIN & Berdo, PC, 1101 14TH STREET, NW, SUITE 500, WASHINGTON, DC, 20005, US

(21) Appl. No.: 10/722,565

(22) Filed: Nov. 28, 2003

(30) Foreign Application Priority Data
Nov. 28, 2002 (JP) 345998/2002

(51) Int. Cl. G06F 17/20

(52) U.S. Cl. 704/8

(57) ABSTRACT

In order to realize an alignment system for multilingual documents as efficiently aligns sentences among the documents of the same contents formed of a plurality of languages, an alignment system for multilingual documents according to the present invention comprises morphological analysis means for dividing the documents in n sorts of languages (: n being a natural number of at least 2), every word, means for selecting two of the n sorts of languages of the documents, means for computing an evaluation function for the documents in the two selected sorts of languages, and means for aligning the documents in the n sorts of languages in accordance with evaluated results.

### FIELD OF THE INVENTION

The present invention relates to a system for the document alignment among documents formed of a plurality of languages. More particularly, it relates to an alignment system for multilingual documents, as well as an aligning method for multilingual documents as aligns the sentences of the multilingual documents described in two or more languages, and also to a program for implementing the method, as well as a record medium storing the program therein.

### BACKGROUND OF THE INVENTION

There have been increased cases of describing documents of the same contents in a plurality of languages, such as the manuals of a product which is expected to be exported to a plurality of countries. In order to evaluate and secure the exactness of the translations of such documents in the plurality of languages, aligning the sentences of these documents is in great demand. A method in which the sentences of bilingual documents are aligned by dynamic programming utilizing a bilingual dictionary, is stated in a prior-art document; “Takehito UTSURO and Yuji MATSUMOTO: Bilingual text matching which employs Bilingual dictionary and Statistic information” (“Computer Software” published by Iwanami Shoten, Publishers, vol. 12, No. 5, September 1995, p. 12 (414)-p. 21 (423)).

According to the prior-art document, in aligning the sentences, each document is segmented every sentence, and the morphological analysis of each sentence is further made so as to be divided every word. Besides, independent words are taken out from among the divisional words, and the alignment is evaluated depending upon how the independent words in the respective sentences correspond to each other (how the semantic contents of the sentences agree), by employing the bilingual dictionary. In the evaluation, a formula as given below is used by way of example.
h(x, y)=2×fₘ(x, y)/(fⱼ(x)+fⱼ(y))

Here,
h(x, y) denotes an evaluation function;
x denotes a sentence (sometimes a plurality of sentences) in an original document;
y denotes a sentence (sometimes a plurality of sentences) in a translated document;
fₘ(x, y) denotes the number of independent words aligned in the sentences x and y;
fⱼ(x) denotes the number of independent words in the sentence x; and
fⱼ(y) denotes the number of independent words in the sentence y.

When the evaluation with such a formula is done, the value of the evaluation function h(x, y) becomes larger (maximum value: 1) as the proportion of the correspondence between the documents is larger, and conversely, the value becomes smaller (minimum value: 0) as the proportion is smaller. The evaluation function is investigated from the heads of the sentences, and a combination in which the sum of the values of the evaluation function becomes the largest is set as the solution of an alignment problem.

With the above method, however, in a case where the alignment of sentences between the ordinary bilingual documents in two languages is applied to the alignment of sentences among documents in three or more languages, the following problems are involved:
Since a plurality of dictionaries are utilized, a record area of considerable size is required for a system.
A long time is expended on the processing of evaluation.
It is difficult to take the matchability of the correspondences of individual language pairs among all the languages.

Moreover, regarding the alignment between the bilingual documents, it is difficult to attain automatic alignment at a high precision, an operator needs to manually perform a check or make corrections while watching the results of the alignment, and the occurrence of the number of man-hours for the operation poses a problem.

The present invention has been made in view of the above problems which are involved in the prior-art alignment system for multilingual documents. Accordingly, an object of the invention is to provide a novel and improved alignment system for multilingual documents and an aligning method for multilingual documents as serve to efficiently align sentences among documents respectively formed of a plurality of languages such as English—Japanese—German.

### SUMMARY OF THE INVENTION

In order to accomplish the above object, and to realize an alignment system for multilingual documents as efficiently align sentences among the documents of the same contents formed of a plurality of languages, an alignment system for multilingual documents according to the present invention comprises morphological analysis means for dividing the documents in n sorts of languages (: n being a natural number of at least 2), every word, means for selecting two of the n sorts of languages of the documents, means for computing an evaluation function for the documents in the two selected sorts of languages, and means for aligning the documents in then sorts of languages in accordance with evaluated results.

### BRIEF DESCRIPTION OF THE DRAWINGS

FIG. 1 is an explanatory block diagram showing the construction of an alignment system for multilingual documents according to the first embodiment of the present invention;

FIG. 2 is a flow chart showing the operation of the alignment system for multilingual documents in FIG. 1;

FIG. 3 is an explanatory block diagram showing the construction of an alignment system for multilingual documents according to the second embodiment;

FIG. 4 is a flow chart showing the operation of the alignment system for multilingual documents in FIG. 3;

FIG. 5 is an explanatory block diagram showing the construction of an alignment system for multilingual documents according to the third embodiment;

FIG. 6 is a flow chart showing the operation of the alignment system for multilingual documents in FIG. 5;

FIG. 7 is an explanatory block diagram showing the construction of an alignment system for multilingual documents according to the fourth embodiment; and

FIG. 8 is a flow chart showing the operation of the alignment system for multilingual documents in FIG. 7.

### DETAILED DESCRIPTION OF THE PREFERRED EMBODIMENTS OF THE INVENTION

Now, preferred embodiments pertinent to an alignment system for multilingual documents according to the present invention, and an aligning method for multilingual documents employing the system will be described in detail with reference to the accompanying drawings.

(First Embodiment)

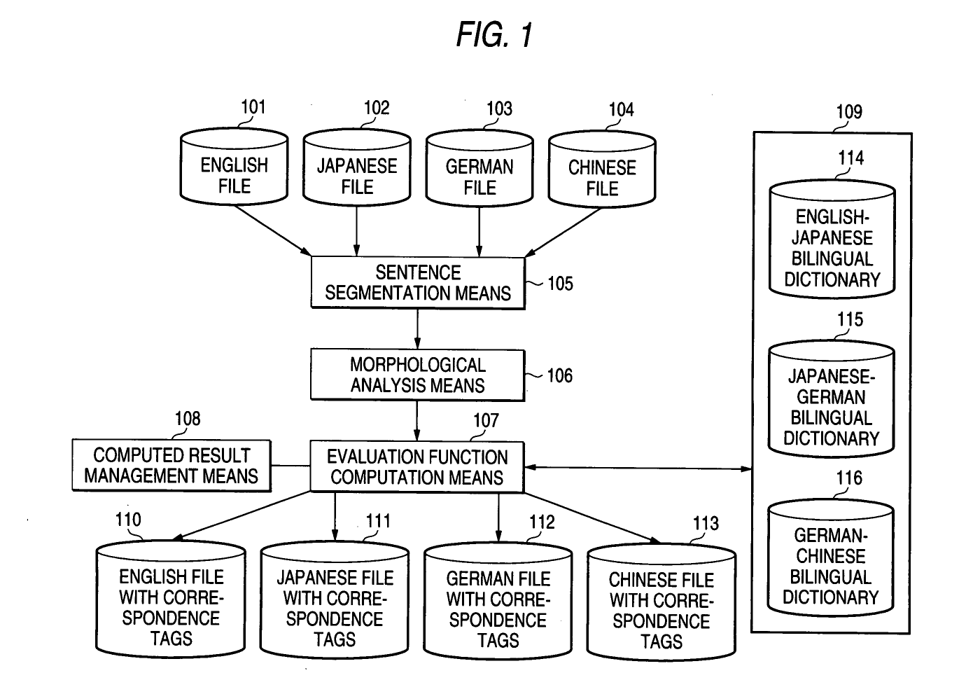

FIG. 1 is an explanatory block diagram showing the construction of an alignment system for multilingual documents, 100 according to the first embodiment of the present invention. As shown in FIG. 1, the alignment system for multilingual documents, 100 includes sentence segmentation means 105, morphological analysis means 106, evaluation function computation means 107, computed result management means 108, and a bilingual dictionary database 109. In this embodiment, files 101-104 in individual languages are inputted, and respective files with correspondence tags, 110-113 are outputted.

The constituents will be described in detail below.

The English file 101 is a document file described in the English language, the Japanese file 102 is a document file described in the Japanese language, the German file 103 is a document file described in the German language, and the Chinese file 104 is a document file described in the Chinese language. Although the four document files differ in the languages used, they contain the same contents, and each of them is in a multilingual form.

The sentence segmentation means 105 segments the document file every sentence. The document is segmented in sentence units by setting, for example, periods “.” and kuten “°” (a punctuation mark which indicates a full stop in a Japanese sentence) as criteria in the English language and the Japanese language, respectively. The morphological analysis means 106 executes morphological analysis processing so as to divide a sentence every word. Existent constructions are applicable as the sentence segmentation means 105 and the morphological analysis means 106, and the details of the processing operations thereof shall be omitted from description.

The evaluation function computation means 107 computes a given evaluation function in order to find the optimal alignment. By way of example, the evaluation function is expressed by the following formula:
h(x, y)=2×fₘ(x, y)/(fⱼ(x)+fⱼ(y))
Here, h(x, y) denotes the evaluation function, x a sentence in one language (original sentence), y a sentence in the other language (translated sentence), fₘ(x, y) the number of independent words aligned in the sentences x and y, fⱼ(x) the number of independent words in the sentence x, and fⱼ(y) the number of independent words in the sentence y.

The computed result management means 108 holds therein results computed by the evaluation function computation means 107, and it outputs the held result when an evaluation function computation already done has arrived again, thereby to prevent the same computation from proceeding repeatedly.

The bilingual dictionary database 109 includes dictionaries for alignment. Each of the dictionaries is one in which, when the word of an original sentence is looked up, one or more words of a translated sentence are contained. In a case, for example, where the original sentence is in English, while the translated sentence is in Japanese, the dictionary corresponds to an English-Japanese dictionary.

The English file with correspondence tags, 110 is such that the English file 101 is endowed with the tags indicating which sentences in the other documents the individual sentences in the pertinent document correspond to. Likewise, the Japanese file with correspondence tags, 111, the German file with correspondence tags, 112 and the Chinese file with correspondence tags, 113 are such that the original Japanese file 102, German file 103 and Chinese file 104 are respectively endowed with the tags indicating which sentences in the other documents the individual sentences in the pertinent documents correspond to.

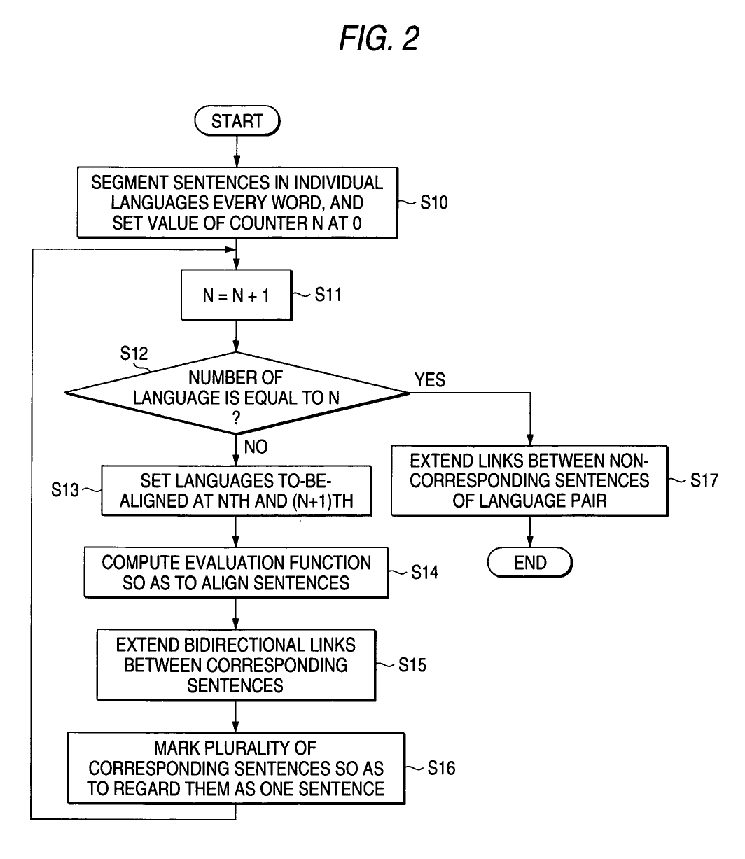

The alignment system for multilingual documents, 100 according to this embodiment is constructed as described above. Next, the operation of the alignment system for multilingual documents, 100 will be described with reference to FIG. 2.

FIG. 2 is a flow chart showing the operation of the alignment system for multilingual documents, 100.

At a step S10, each of the document file in one language (original) and the document file in the other language (translation) is subjected to sentence segmentation by the sentence segmentation means 105. Besides, a counter N indicating to what places alignment has been executed is set at 0.

At a step S11, the counter N is incremented (+1).

At a step S12, if the number of languages to be aligned is equal to the count of the counter N is checked. If the number is equal to the count, the routine proceeds to a step S17, and if not, the routine proceeds to a step S13.

At the step S13, the languages to be aligned are set at the Nth and (N+1)th.

At a step S14, the evaluation function computation means 107 aligns sentences for the set languages.

At a step S15, bidirectional links are extended between the corresponding sentences for an aligned result.

At a step S16, marks are put on sentences which have fallen into the correspondences of pluralities of sentences such as at 2-to-1 and 3-to-1. The combination of the marked sentences is regarded as one sentence and then processed in case of performing the next alignment operation.

Meanwhile, at the step S17, links are extended between sentences in the languages not aligned, by utilizing the aligned results between the other languages.

The above processing will be described by taking as an example the case where the alignment among the four languages (n=4) is carried out as in FIG. 1. In this example, English corresponds to the first language, Japanese the second language, German the third language, and Chinese the fourth language.

First, each of documents in the four languages is segmented every sentence by the sentence segmentation means 105.

Subsequently, the sentences are aligned. The alignment between English and Japanese is done using the English-Japanese bilingual dictionary 114, the alignment between Japanese and German is done using Japanese-German bilingual dictionary 115, and the alignment between German and Chinese is done using the German-Chinese bilingual dictionary 116. Thus, the links of the sentences in (n−1) sorts in total are generated between English and Japanese, between Japanese and German, and between German and Chinese.

Further, the links of sentences are extended between the languages not aligned (here, between Japanese and Chinese, between English and German, and between English and Chinese), whereby the correspondences among all the languages can be taken.

As described above, according to this embodiment, the correspondences of sentences can be efficiently taken with a small storage capacity and without requiring a very long time, though the precision of alignment is somewhat low.

(Second Embodiment)

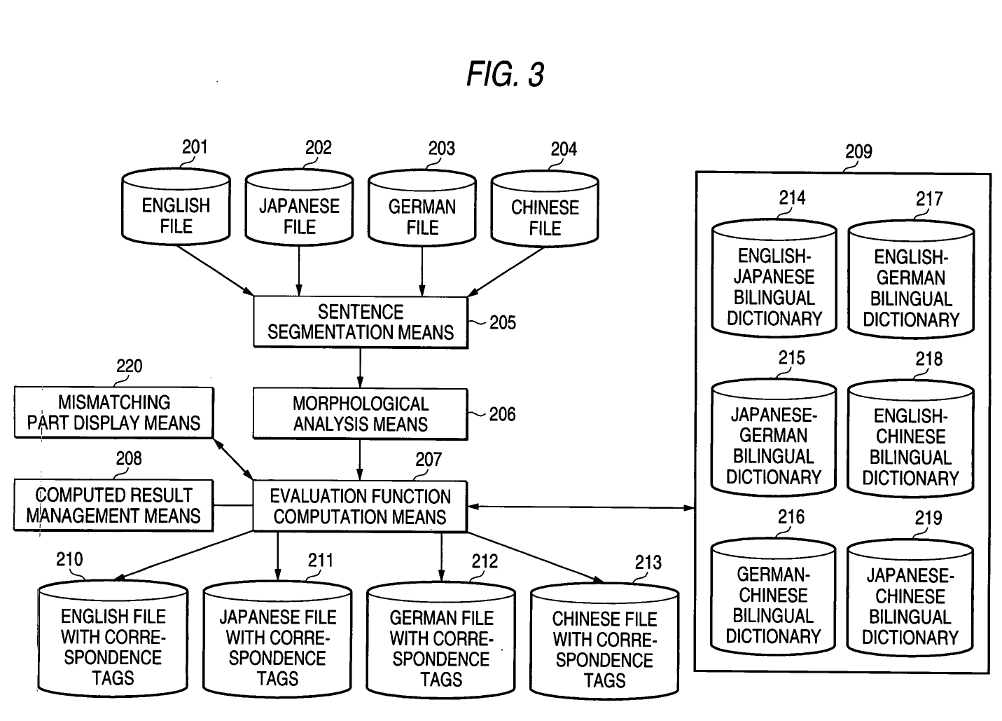

FIG. 3 shows the construction of an alignment system for multilingual documents, 200 according to the second embodiment.

An English file 201 is a document file described in the English language, a Japanese file 202 is a document file described in the Japanese language, a German file 203 is a document file described in the German language, and a Chinese file 204 is a document file described in the Chinese language. Although the four document files differ in the languages used, they contain the same contents, and each of them is in a multilingual form.

Sentence segmentation means 205 segments the document file every sentence. The document is segmented in sentence units by setting, for example, periods “.” and kuten “°” (a punctuation mark which indicates a full stop in a Japanese sentence) as criteria in the English language and the Japanese language, respectively. Morphological analysis means 206 executes morphological analysis processing so as to divide a sentence every word. Existent constructions are applicable as the sentence segmentation means 205 and the morphological analysis means 206, and the details of the processing operations thereof shall be omitted from description.

Evaluation function computation means 207 computes a given evaluation function in order to find the optimal alignment. Applicable as the evaluation function is, for example, the formula of the evaluation function employed in the first embodiment.

Computed result management means 208 holds therein results computed by the evaluation function computation means 207, and it outputs the held result when an evaluation function computation already done has arrived again, thereby to prevent the same computation from proceeding repeatedly.

A bilingual dictionary database 209 includes dictionaries for alignment. Each of the dictionaries is one in which, when the word of an original sentence is looked up, one or more words of a translated sentence are contained. In a case, for example, where the original sentence is in English, while the translated sentence is in Japanese, the dictionary corresponds to an English-Japanese dictionary.

An English file with correspondence tags, 210 is such that the English file 201 is endowed with the tags indicating which sentences in the other documents the individual sentences in the pertinent document correspond to. Likewise, a Japanese file with correspondence tags, 211, a German file with correspondence tags, 212 and a Chinese file with correspondence tags, 213 are such that the original Japanese file 202, German file 203 and Chinese file 204 are respectively endowed with the tags indicating which sentences in the other documents the individual sentences in the pertinent documents correspond to.

Mismatching part display means 220 has the function of displaying any mismatching part existent in aligned results, and allowing a user to correct the mismatching part. The “mismatching part” implies, for example, a case where, when an English sentence En and a Japanese sentence Jn correspond, and the Japanese sentence Jn and a German sentence Dn correspond, the English sentence En and the German sentence Dn do not correspond in the light of the aligned result between the English and German languages.

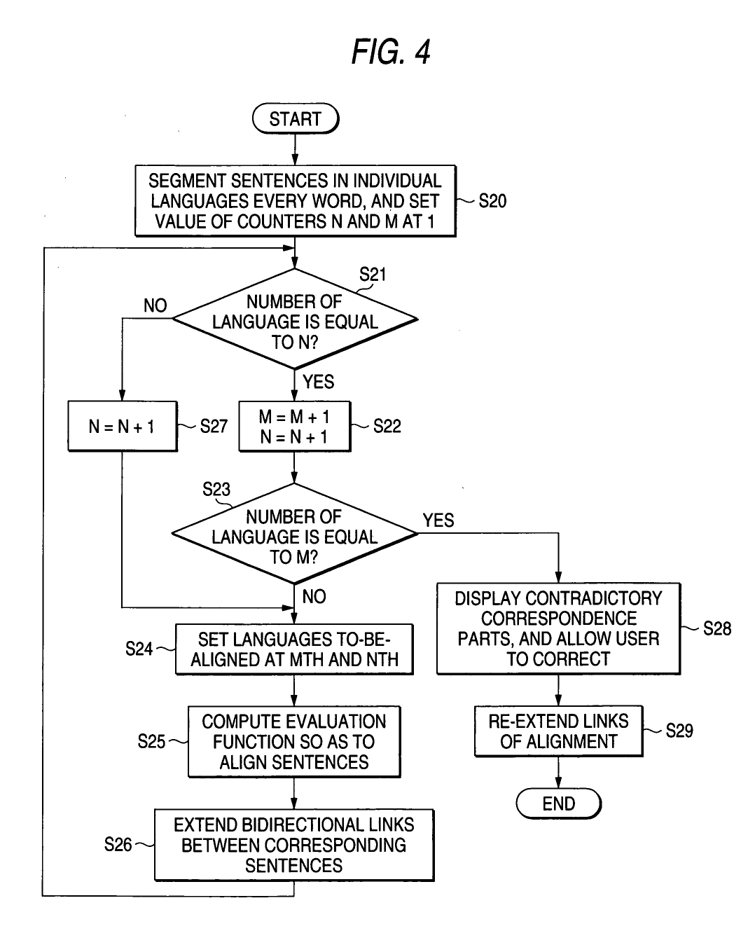

FIG. 4 is a flow chart showing the operation of the alignment system for multilingual documents, 200 in this embodiment.

At a step S20, each of the document file in one language (original) and the document file in the other language (translation) is subjected to sentence segmentation by the sentence segmentation means 205. Besides, counters N and M indicating to what places alignment has been executed are set at 1.

At a step S21, if the number of languages to be aligned is equal to the count of the counter N is checked. If the number is equal to the count, the routine proceeds to a step S22, and if not, the routine proceeds to a step S27.

At the step S22, the counter M is incremented, and the count of the counter N is set at (M+1).

At a step S23, if the number of languages to be aligned is equal to the count of the counter M is checked. If the number is equal to the count, the routine proceeds to a step S28, and if not, the routine proceeds to a step S24.

At the step S24, the languages to be aligned are set at the Mth and Nth.

At a step S25, the evaluation function computation means 207 aligns sentences for the set languages.

At a step S26, bidirectional links are extended between the corresponding sentences for an aligned result.

Meanwhile, at the step S27, the counter N is incremented.

Further, at the step S28, mismatching parts in the correspondences of the sentences are displayed, and a user is allowed to correct them.

At a step S29, the links of the alignment are re-extended in accordance with the user's corrections.

In this way, the sentences in the n sorts of languages are aligned in all combinations (in this embodiment, in n(n−1)/2=6 sorts for the sorts of the languages, n=4).

As described above, according to this embodiment, alignments at a high precision can be efficiently incarnated though the user's correction processing is indispensable.

(Third Embodiment)

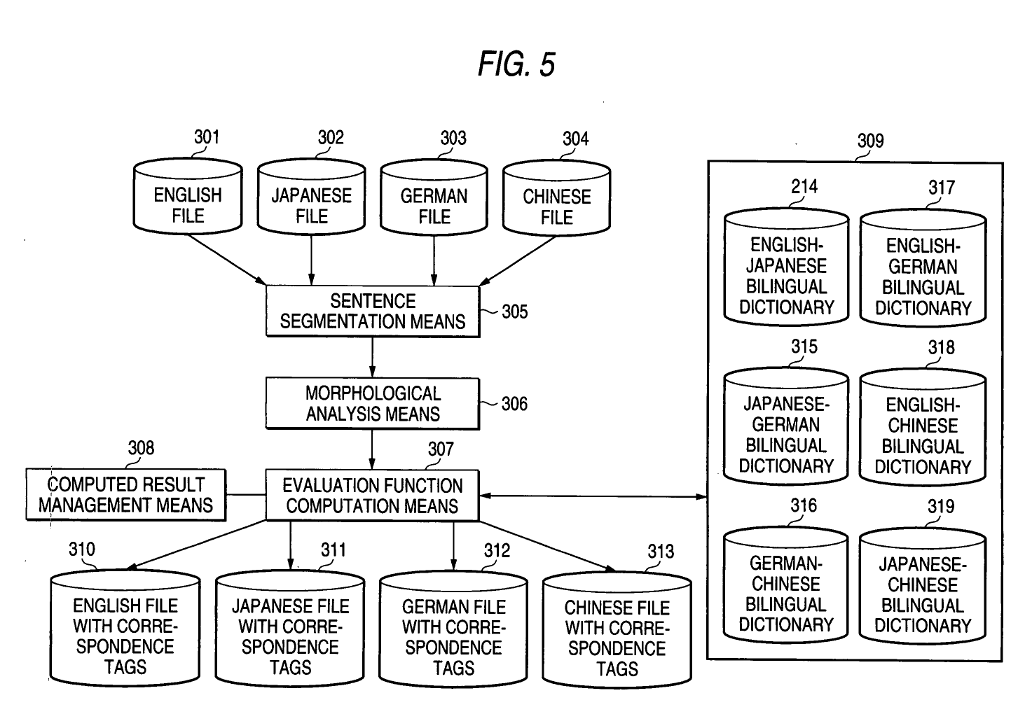

FIG. 5 shows the construction of an alignment system for multilingual documents, 300 according to the third embodiment.

An English file 301 is a document file described in the English language, a Japanese file 302 is a document file described in the Japanese language, a German file 303 is a document file described in the German language, and a Chinese file 304 is a document file described in the Chinese language. Although the four document files differ in the languages used, they contain the same contents, and each of them is in a multilingual form.

Sentence segmentation means 305 segments the document file every sentence. The document is segmented in sentence units by setting, for example, periods “.” and kuten “°” (a punctuation mark which indicates a full stop in a Japanese sentence) as criteria in the English language and the Japanese language, respectively. Morphological analysis means 306 executes morphological analysis processing so as to divide a sentence every word. Existent constructions are applicable as the sentence segmentation means 305 and the morphological analysis means 306, and the details of the processing operations thereof shall be omitted from description.

Evaluation function computation means 307 computes a given evaluation function in order to find the optimal alignment. Applicable as the evaluation function is, for example, the formula of the evaluation function employed in the first embodiment.

Computed result management means 308 holds therein results computed by the evaluation function computation means 307, and it outputs the held result when an evaluation function computation already done has arrived again, thereby to prevent the same computation from proceeding repeatedly.

A bilingual dictionary database 309 includes dictionaries for alignment. Each of the dictionaries is one in which, when the word of an original sentence is looked up, one or more words of a translated sentence are contained. In a case, for example, where the original sentence is in English, while the translated sentence is in Japanese, the dictionary corresponds to an English-Japanese dictionary.

An English file with correspondence tags, 310 is such that the English file 301 is endowed with the tags indicating which sentences in the other documents the individual sentences in the pertinent document correspond to. Likewise, a Japanese file with correspondence tags, 311, a German file with correspondence tags, 312 and a Chinese file with correspondence tags, 313 are such that the original Japanese file 302, German file 303 and Chinese file 304 are respectively endowed with the tags indicating which sentences in the other documents the individual sentences in the pertinent documents correspond to.

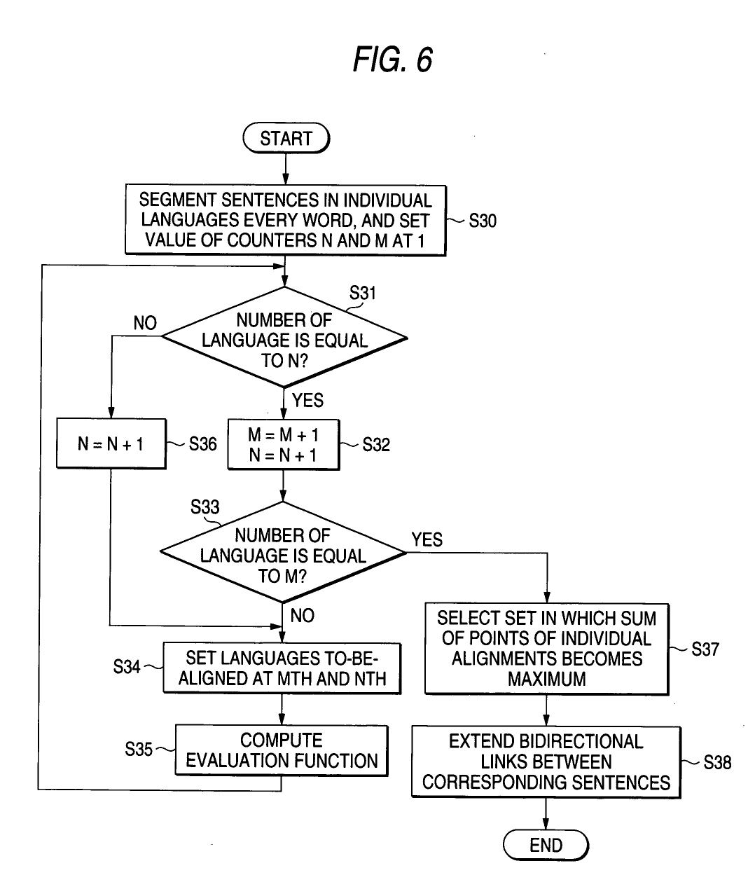

FIG. 6 is a flow chart showing the operation of the alignment system for multilingual documents, 300 in this embodiment.

At a step S30, each of the document file in one language (original) and the document file in the other language (translation) is subjected to sentence segmentation by the sentence segmentation means 305. Besides, counters N and M indicating to what places alignment has been executed are set at 1.

At a step S31, if the number of languages to be aligned is equal to the count of the counter N is checked. If the number is equal to the count, the routine proceeds to a step S32, and if not, the routine proceeds to a step S36.

At the step S32, the counter M is incremented, and the count of the counter N is set at (M+1).

At a step S33, if the number of languages to be aligned is equal to the count of the counter M is checked. If the number is equal to the count, the routine proceeds to a step S37, and if not, the routine proceeds to a step S34.

At the step S34, the languages to be aligned are set at the Mth and Nth.

At a step S35, the evaluation function computation means 307 aligns sentences for the set languages.

Meanwhile, at the step S36, the counter N is incremented.

Further, at the step S37, that combination of sentences in which the sum of the points of individual alignments becomes the maximum is selected.

At a step S38, bidirectional links are extended between the corresponding sentences.

The above processing will be described by taking as an example the case where the alignment among the four languages (n=4) is carried out as in FIG. 5. In this example, English corresponds to the first language, Japanese the second language, German the third language, and Chinese the fourth language.

First, each of documents in the four languages is segmented every sentence by the sentence segmentation means 305. Subsequently, an evaluation function in each of the combinations of all the documents is computed. In this case, six evaluation functions are computed between English and Japanese, between English and German, between English and Chinese, between Japanese and German, between Japanese and Chinese, and between German and Chinese.

Subsequently, correspondences are taken so that the sum of alignment points may become the largest. The correspondences are collectively and simultaneously taken for the four languages. By way of example, the evaluation point of one English sentence, one Japanese sentence, two German sentences, and one Chinese sentence becomes the sum of the evaluation points of one-to-one of English and Japanese sentences, one-to-two of English and German sentences, one-to-one of English and Chinese sentences, one-to-two of Japanese and German sentences, one-to-one of Japanese and Chinese sentences, and two-to-one of German and Chinese sentences. The computation is continued so as to obtain the correspondences affording the largest sum of the evaluation points, as the correct solution of the alignment.

As described above, according to this embodiment, alignments at a high precision can be efficiently incarnated though a processing time period increases.

(Fourth Embodiment)

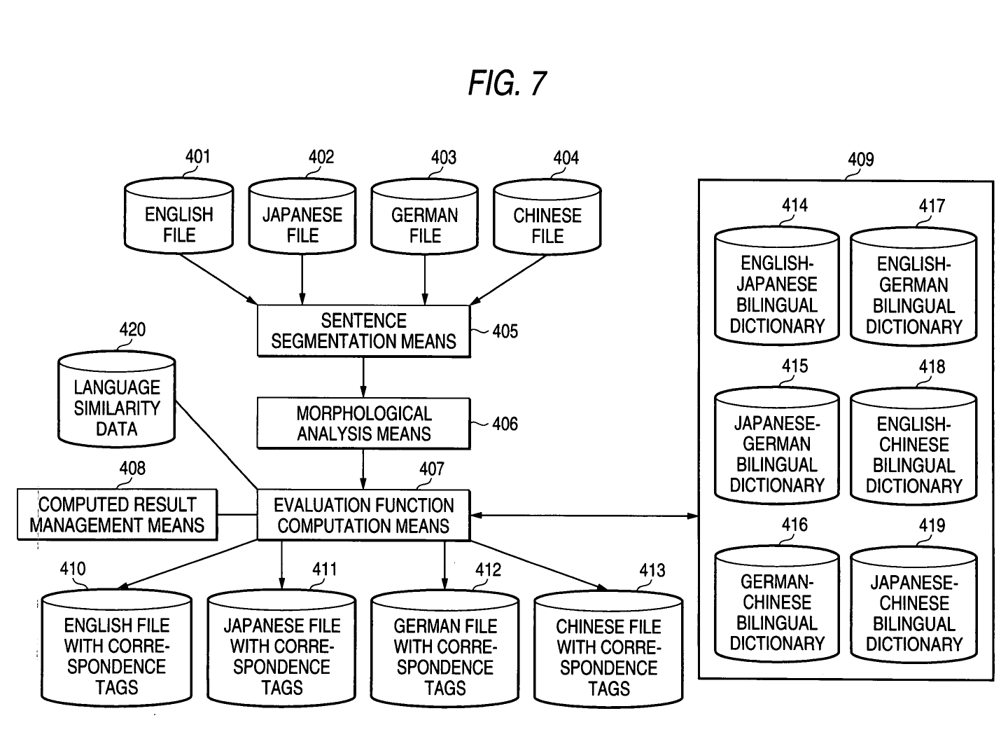

FIG. 7 shows the construction of an alignment system for multilingual documents, 400 according to the fourth embodiment.

An English file 401 is a document file described in the English language, a Japanese file 402 is a document file described in the Japanese language, a German file 403 is a document file described in the German language, and a Chinese file 404 is a document file described in the Chinese language. Although the four document files differ in the languages used, they contain the same contents, and each of them is in a multilingual form.

Sentence segmentation means 405 segments the document file every sentence. The document is segmented in sentence units by setting, for example, periods “.” and kuten “°” (a punctuation mark which indicates a full stop in a Japanese sentence) as criteria in the English language and the Japanese language, respectively. Morphological analysis means 406 executes morphological analysis processing so as to divide a sentence every word. Existent constructions are applicable as the sentence segmentation means 405 and the morphological analysis means 406, and the details of the processing operations thereof shall be omitted from description.

Evaluation function computation means 407 computes a given evaluation function in order to find the optimal alignment. Applicable as the evaluation function is, for example, the formula of the evaluation function employed in the first embodiment.

Computed result management means 408 holds therein results computed by the evaluation function computation means 407, and it outputs the held result when an evaluation function computation already done has arrived again, thereby to prevent the same computation from proceeding repeatedly.

A bilingual dictionary database 409 includes dictionaries for alignment. Each of the dictionaries is one in which, when the word of an original sentence is looked up, one or more words of a translated sentence are contained. In a case, for example, where the original sentence is in English, while the translated sentence is in Japanese, the dictionary corresponds to an English-Japanese dictionary.

An English file with correspondence tags, 410 is such that the English file 401 is endowed with the tags indicating which sentences in the other documents the individual sentences in the pertinent document correspond to. Likewise, a Japanese file with correspondence tags, 411, a German file with correspondence tags, 412 and a Chinese file with correspondence tags, 413 are such that the original Japanese file 402, German file 403 and Chinese file 404 are respectively endowed with the tags indicating which sentences in the other documents the individual sentences in the pertinent documents correspond to.

Language similarity data 420 are values obtained by digitizing how the grammars, etc. of languages are similar. As the similarity between the grammars of the languages is higher, the degree of the alignment of sentences is enhanced more. In the language similarity data 420, therefore, the values of the similarities of individual language pairs are recorded in, for example, a tabular form.

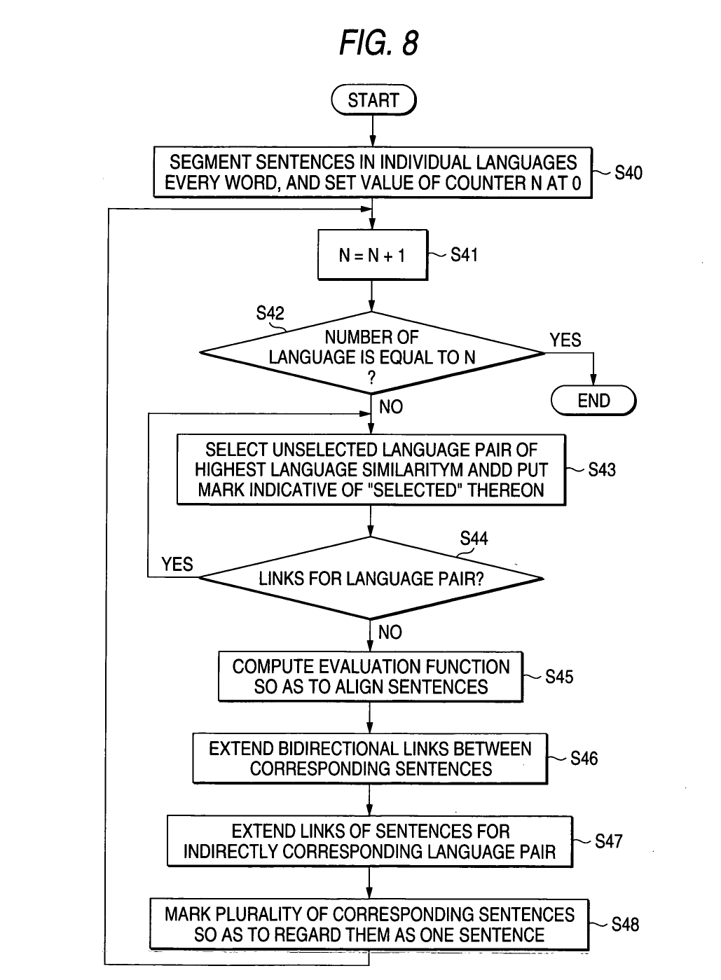

FIG. 8 is a flow chart showing the operation of the alignment system for multilingual documents, 400 in this embodiment.

At a step S40, each of the document file in one language (original) and the document file in the other language (translation) is subjected to sentence segmentation by the sentence segmentation means 405. Besides, a counter N indicating to what places alignment has been executed is set at 0.

At a step S41, the counter N is incremented.

At a step S42, if the number of languages to be aligned is equal to the count of the counter N is checked. If the number is equal to the count, the routine is ended, and if not, the routine proceeds to a step S43.

At the step S43, among language pairs not selected yet, one of the highest language similarity is selected on the basis of the language similarity data 420, and a mark indicative of “selected” is put on the selected language pair.

At a step S44, if the links of sentence correspondences are extended for the language pair is checked. If the links are extended, the routine returns to the step S43, and if not, the routine proceeds to a step S45.

At the step S45, the evaluation function computation means 407 aligns sentences for the selected languages.

At a step S46, bidirectional links are extended between the corresponding sentences for an aligned result.

At a step S47, marks are put on sentences which have fallen into the correspondences of pluralities of sentences such as at 2-to-1 and 3-to-1. The combination of the marked sentences is regarded as one sentence and then processed in case of performing the next alignment operation.

At a step S48, links are extended for indirectly aligned languages. Assuming, for example, that alignments have been done between English and Japanese and between English and German, the alignment between Japanese and German can be found by utilizing the two alignments, and the links of sentence correspondences are also extended for the found alignment between Japanese and German.

As described above, according to this embodiment, alignments at high speed and at a high precision can be efficiently incarnated by preparing language similarity data.

“Speeds”, “precisions” and “storage capacities used” in the four embodiments will be compared in Table 1 below. In the table, mark “OO” indicates “excellent”, mark “O” indicates “good”, and mark “Δ” indicates “ordinary”.O

TABLE 1

| EMBODI- | | | STORAGE | |
|---|---|---|---|---|
| MENT | SPEED | PRECISION | CAPACITY | REMARKS |
| 1 | ◯◯ | Δ | ◯◯ | |
| 2 | ◯ | ◯◯ | Δ | User's correc- |
| | | | | tions are |
| | | | | necessary. |
| 3 | Δ | ◯◯ | Δ | |
| 4 | ◯◯ | ◯ | ◯ | Language similarity |
| | | | | data are necessary. |

Although the preferred embodiments of the alignment system for multilingual documents and the aligning method for multilingual documents according to the present invention have been described above with reference to the accompanying drawings, the invention is not restricted to the constructions of these embodiments. A person skilled in the art can obviously consider various modifications or alterations within the category of technical ideas defined in the appended claims, and they ought to fall within the technical scope of the invention.

By way of example, although the alignments among English, Japanese, German and Chinese have been mentioned in each of the first—fourth embodiments, any languages can be aligned by changing bilingual dictionaries.

Besides, although the number of languages has been exemplified as four (n=4) in each of the embodiments, the invention is applicable to the alignment between any two or more languages. Further, a processing time period in the second or third embodiment is apprehended to become very long when the number of languages increases, it can be shortened by decreasing the number of corresponding combinations to-be-computed.

Incidentally, the aligning method for multilingual documents according to the present invention can also be described as a software program, which can also be recorded on a record medium.

As thus far described, the present invention can provide an alignment system for multilingual documents as efficiently aligns sentences between documents formed of a plurality of languages.

1. An alignment system for multilingual documents as aligns the documents in n sorts (: n being a natural number of at least 2) of languages, comprising:
morphological analysis means for dividing the document in each of the languages, every word;
means for selecting two of the n sorts of languages of the documents;
means for computing an evaluation function for the documents in the two selected sorts of languages; and
means for aligning the documents in the n sorts of languages, in accordance with an evaluated result for the documents in the two sorts of languages.

2. An alignment system for multilingual documents as defined in claim 1, wherein said morphological analysis means includes means for segmenting the document in each of the languages, every sentence, and means for further dividing each of the segmental sentences, every word.

3. An alignment system for multilingual documents as defined in claim 1, wherein said means for selecting two of the n sorts of languages of the documents selects (n−1) combinations of the kth and (k+1)th documents (: k being a natural number of 1 to (n−1)) when the documents in the n sorts of languages are arranged in any desired sequence.

4. An alignment system for multilingual documents as defined in claim 1, wherein said means for selecting two of the n sorts of languages of the documents selects n(n−1)/2 combinations.

5. An alignment system for multilingual documents as defined in claim 1, further comprising computed result holding means for holding therein results computed with the evaluation function.

6. An alignment system for multilingual documents as defined in claim 1, wherein the evaluation function is expressed by the following formula:
h(x, y)=2×fₘ(x, y)/(fⱼ(x)+fⱼ(y))
where h(x, y) denotes the evaluation function, x denotes a sentence in one language (original sentence), y a sentence in the other language (translated sentence), fₘ(x, y) the number of independent words aligned in the sentences x and y, fⱼ(x) the number of independent words in the sentence x, and fⱼ(y) the number of independent words in the sentence y.

7. An alignment system for multilingual documents as defined in claim 1, further comprising means for displaying any mismatching part when alignments of the documents in at least three of the n sorts of languages of the documents have mismatched.

8. An alignment system for multilingual documents as defined in claim 1, wherein said means for computing an evaluation function aligns the documents while optimizing the alignment so that a sum of values of the evaluation function may be maximized.

9. An alignment system for multilingual documents as defined in claim 1, further comprising means for indicating a language pair which affords a high correct solution rate of the alignment, while investigating similarity data between the pair of languages.

10. An aligning method for multilingual documents as aligns documents in n sorts (: n being a natural number of at least 2) of languages, comprising:
the morphological analysis step of dividing the document in each of the languages, every word;
the step of selecting two of the n sorts of languages of the documents;
the step of computing an evaluation function for the documents in the two selected languages; and
the step of aligning the documents in the n sorts of languages, in accordance with an evaluated result for the documents in the two sorts of languages.

11. A program in which the steps for causing a computer to implement the aligning method for multilingual documents as defined in claim 10 are described.
